(19) United States
(12) Patent Application Publication
(10) Pub. No.: US 2007/0284363 A1
(43) Pub. Date: Dec. 13, 2007

(54) Temperature control apparatus of heating jacket

(76) Inventor: Yoon-Hae Kim, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/636,987

(22) Filed: Dec. 12, 2006

(30) Foreign Application Priority Data
Jun. 12, 2006 (KR) 2006-0052415

(51) Int. Cl. B23K 13/08

(52) U.S. Cl. 219/482

(57) ABSTRACT

A temperature control apparatus of a gas pipe heating jacket prevents a heat transfer through a pipe having unreactive residual gas and maintains the temperature of the gas in the event that a first hot wire in the heating jacket is damaged or otherwise inoperable through the use of a second hot wire. By maintaining the temperature of the gas flowing through the pipe, crystallization due to heat differences is avoided thereby preventing pipe blockage and subsequent process errors. The temperature control apparatus includes a controller, a power supply controller, first and second hot wires, a relay, a temperature sensor and a display. The first and second hot wires heat the gas pipe with AC power supplied from power supply controller. The relay selectively supplies the AC power to the first or second hot wire in response to the relay switching signal from the controller. The temperature sensor senses a heating temperature of the gas pipe. A display individually indicates drive states of the first and second hot wires in response to the control signal from the controller.

### BACKGROUND OF THE INVENTION

1. Field of the Invention

The present invention relates to gas pipe heating jackets, and more particularly, to a temperature control apparatus of a gas pipe heating jacket, which is capable of preventing a heat transfer through a pipe, in a gas pipe having unreactive residual gas, and of constantly maintaining temperature of the gas.

This application claims priority under 35 U.S.C. §119 from Korean Patent Application 10-2006-0052415, filed on Jun. 12, 2006, the entire contents of which are hereby incorporated by reference.

2. Discussion of Related Art

In general, semiconductor devices are manufactured using many fabrication steps or processes. Many of these processes use various types of gases in a high-vacuum state. Typically, a process chamber is coupled to a vacuum device through an exhaust pipe in order to form a vacuum state of a reaction chamber in which the processes are performed on a semiconductor substrate. The vacuum device controls a pressure of the process chamber and is used to discharge reactive gas remaining within the chamber, reactive by-products and unreactive gases generated during the particular process.

A gas pipe is used to discharge the unreactive gas and reactive by-products from the chamber. This gas pipe may be blocked due to a temperature difference between the interior and exterior of the chamber. Because of this temperature difference, the unreactive gas and reactive by-products may crystallize into a solid state, such as a powder, at a low temperature. The solid crystals may adhere to the interior of the gas pipe and block gases from being discharged from the chamber during manufacturing.

FIG. 1 illustrates a temperature control apparatus of a conventional gas pipe that includes a rectifying unit 10 for receiving an AC power source which drops a voltage and outputs a DC power source. A microprocessor unit (MPU) 12 receives DC power supplied from rectifying unit 12 and outputs a control signal to heat a hot wire 20 to a predetermined temperature in response to a digital temperature sense signal. A power supply controller 14 constructed of an SSR (Solid State Relay), supplies or cuts-off the AC power in response to the control signal from MPU 12. Hot wire 20 surrounds and heats gas pipe 16 using AC power supplied from power supply controller 14. A temperature sensor 22 senses the temperature of hot wire 20 and A/D converter 24 converts the temperature sensed by temperature sensor 22 into a digital signal and provides it to MPU 12. A temperature display 26 indicates a temperature value in response to the control signal from MPU 12. Heating jacket 18 may be configured to include hot wire 20 and temperature sensor 22.

FIG. 2A illustrates an assembled heating jacket 18 and FIG. 2B illustrates a disassembled heating jacket 18 shown in FIG. 1. The heating jacket 18 includes a first insulation layer 30 that surrounds gas pipe 16 and provides electrical insulation between gas pipe 16 and the hot wire. A second insulation layer 32 surrounds hot wire 20 and provides electrical insulation therefore. A fixation layer 34 surrounds second insulation layer 32 and prevents displacement of this insulation layer. First insulation layer 30 surrounds the girth of gas pipe 16. Hot wire 20 is wound around first insulation layer 30 and second insulation layer 32 surrounds hot wire 20. In this heating jacket 18 configuration, the temperature of the gas flowing in gas pipe 16 is heated to a predetermined temperature by hot wire 20. In particular, power is supplied and a voltage is dropped and rectified in rectifying unit 10. This DC voltage is applied to MPU 12 and temperature display 26. The MPU 12 turns on power supply controller 14 to supply AC power to hot wire 20 which heats gas pipe 16. The gas flowing in pipe 16 is in turn heated such that the gas does not adhere in a solid state to gas pipe 16.

A temperature sensor 22 senses the temperature of gas pipe 16 and applies the sensed temperature to A/D converter 24 which converts the sensed temperature into a digital signal and supplies it to MPU 12. MPU 12 compares the sensed digital temperature with a predetermined temperature. If the sensed temperature is lower than the predetermined temperature, power supply controller 14 is turned on to supply AC power to hot wire 20 to heat gas pipe 16. If the sensed temperature is higher than the predetermined temperature, power supply controller 14 cuts-off AC power supplied to hot wire 20.

A drawback associated with such a temperature control apparatus is that if hot wire 20 is damaged or otherwise not functioning properly, the temperature of heating jacket 18 may become lower than the predetermined temperature. The gas flowing through the pipe cools and changes to a solid crystalline state, such as powder, and adheres to the interior of gas pipe 16 thereby blocking gas flow and causing process errors.

### SUMMARY OF THE INVENTION

Exemplary embodiments of the present invention are directed to a temperature control apparatus of a gas pipe heating jacket to control the temperature of gas flowing in a pipe during a semiconductor manufacturing process where the heating jacket includes first and second hot wires. The apparatus includes a temperature sensor configured to sense the temperature of the first and second hot wires and a controller. The controller receives the sensed temperature signal and outputs a control signal to heat the first or second hot wires to a predetermined temperature in response to the sensed temperature signal. The controller further outputs a relay switching signal to heat the first or second hot wires when the sensed temperature does not reach an associated predetermined temperature within a predetermined time period. A display is also utilized to indicate drive states of the first and second hot wires in response to the control signal. In this manner, if the first hot wire is damaged or is otherwise inoperable, a second hot wire heats the gas pipe thereby avoiding solids from forming within the pipe.

### BRIEF DESCRIPTION OF THE DRAWINGS

FIG. 1 illustrates the configuration of temperature control apparatus of a conventional gas pipe;

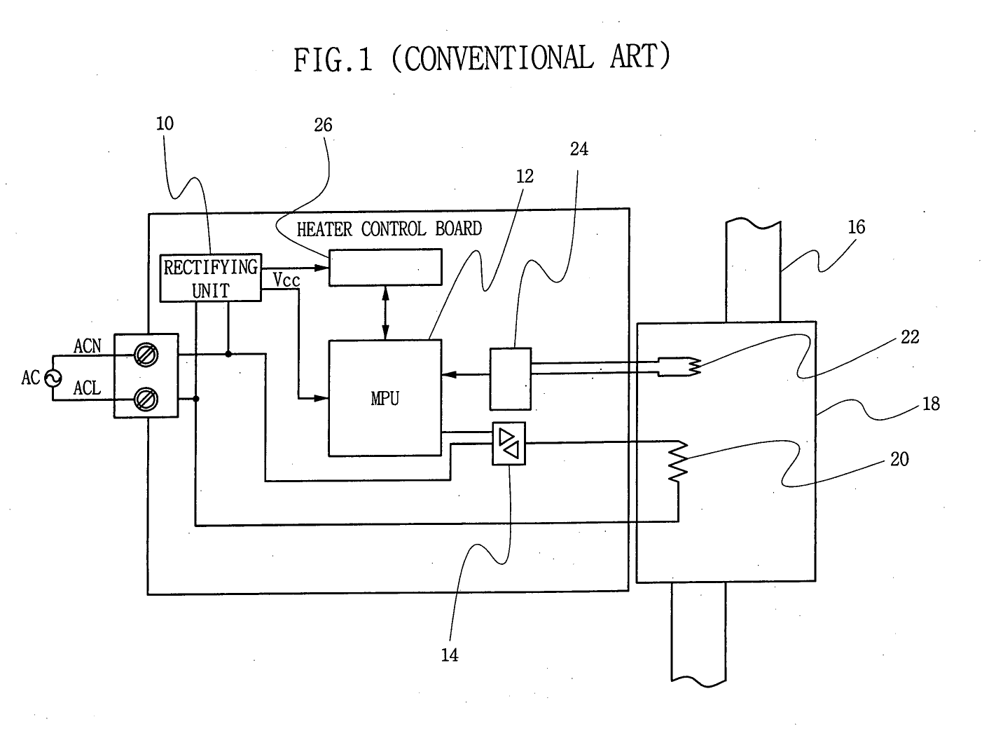

FIG. 2A illustrates an assembled state of heating jacket shown in FIG. 1;

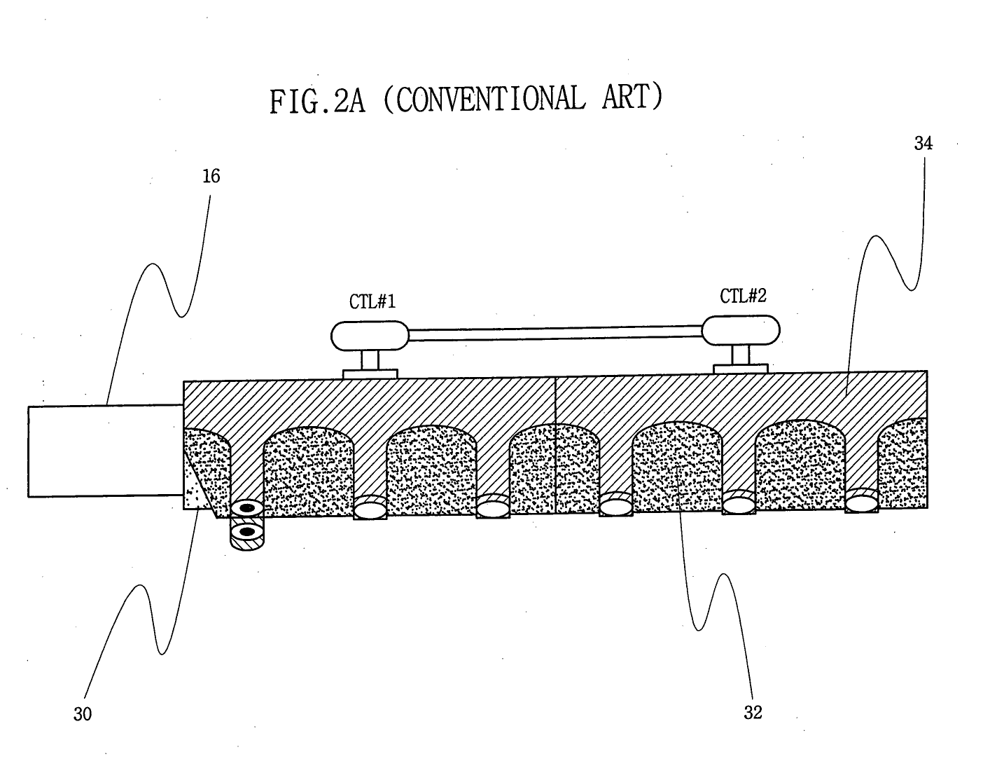

FIG. 2B illustrates a disassembled state of the heating jacket shown in FIG. 1;

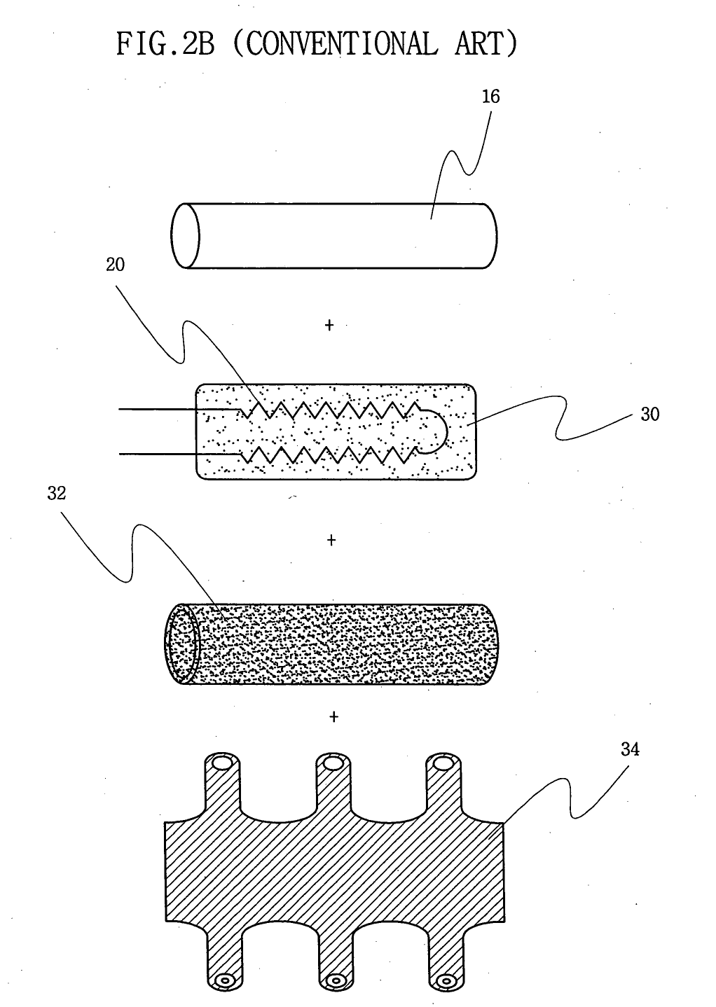

FIG. 3 illustrates the configuration of a temperature control apparatus of a gas pipe according to an embodiment of the invention;

FIG. 4A illustrates an assembled state of heating jacket shown in FIG. 3;

FIG. 4B illustrates a disassembled state of the heating jacket shown in FIG. 3;

FIG. 5 is a flowchart of a process to switch from one hot wire to another hot wire in accordance with an embodiment of the invention;

FIG. 6 illustrates the configuration of a temperature control apparatus of a gas pipe according to an embodiment of the invention; and

FIG. 7 is a flowchart of a process to switch to a hot wire when another hot wire is damaged, according to an embodiment of the invention.

### DESCRIPTION OF EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

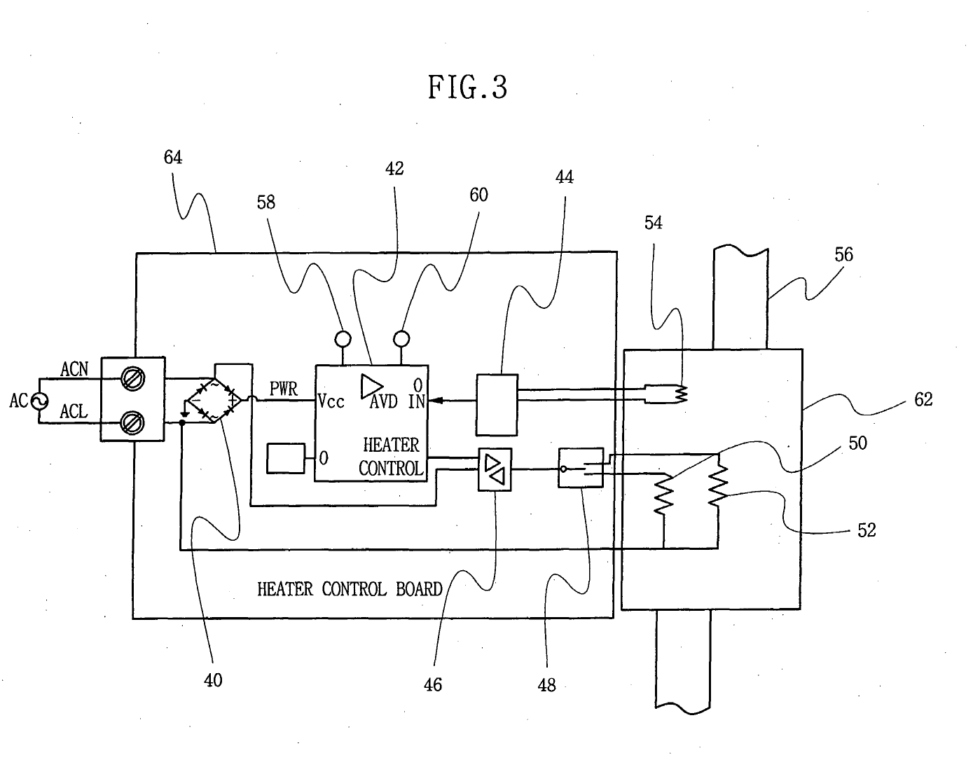

FIG. 3 illustrates a temperature control apparatus in combination with gas pipe 56 including a heater control board 64 and a heating jacket 62 having first and second hot wires 50 and 52. Heater control board 64 includes a rectifying unit 40, an MPU 42, a power supply controller 46, A/D converter 44 and relay 48. Rectifying unit 40 receives AC power, drops a voltage, rectifies it and outputs DC power to MPU 42. MPU 42 outputs a control signal to heat heating jacket 62 to a predetermined temperature in response to a digital temperature sense signal. MPU 42 also outputs a relay switching signal when the temperature of heating jacket 62 does not reach a predetermined temperature within a predetermined time period.

Power supply controller 46, constructed of an SSR(Solid State Relay), supplies or cuts-off the supply of AC power to hot wires 50 and 52 in response to the control signal from MPU 42. Relay 48 selectively supplies AC power provided by power supply controller 46 to first or second hot wires 50, 52 in response to a relay switching signal from MPU 42. Temperature sensor 54 senses the temperature of first and second hot wires 50 and 52. A/D converter 44 converts the temperature sensed by temperature sensor 54 into a digital signal and provides it to MPU 42. Heater control board 64 also includes first and second LEDs 58 and 60 which indicate a drive state of the first and second hot wires 50 and 52 in response to the control signal from MPU 42. First hot wire 50 and temperature sensor 54 may be included in heating jacket 62.

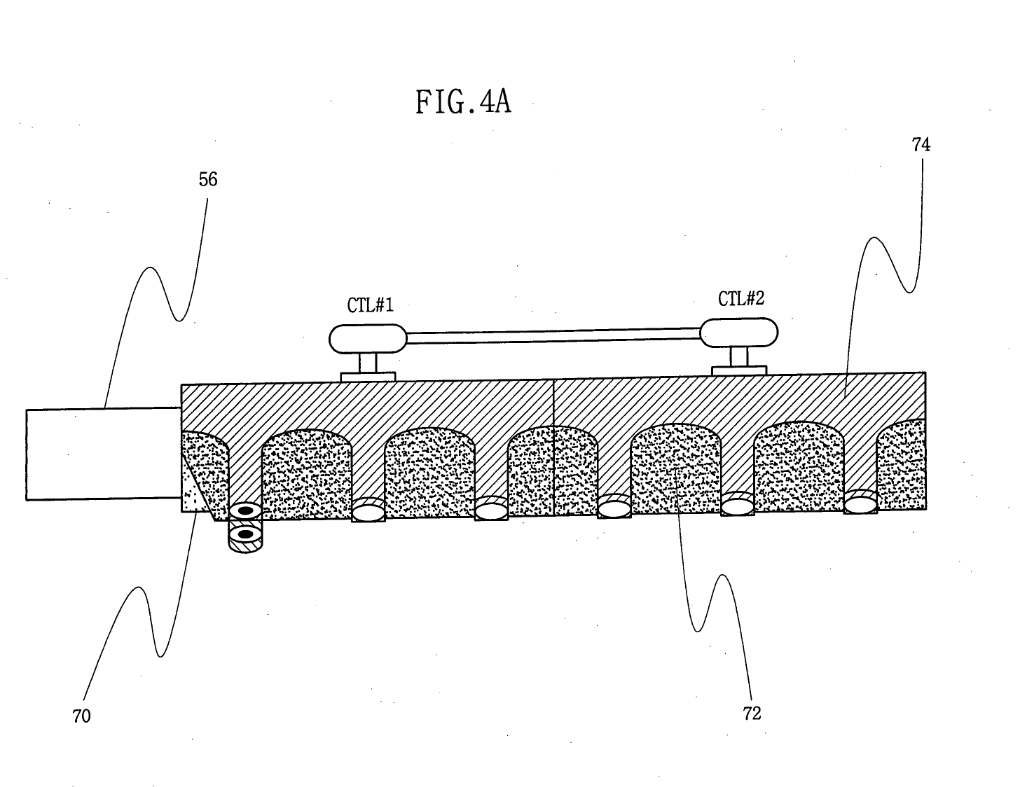

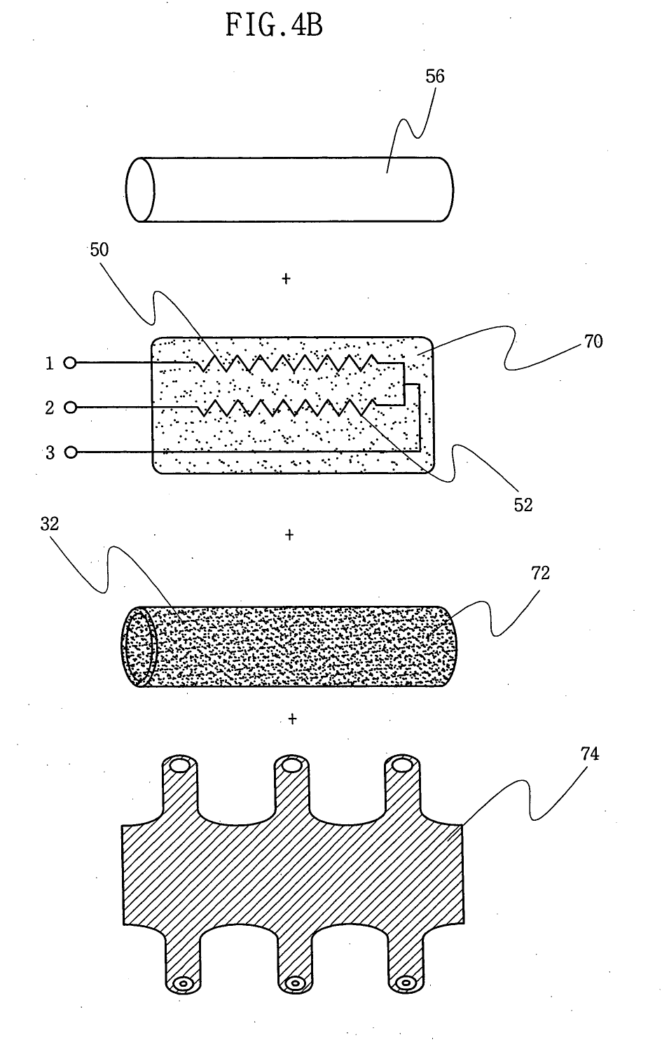

FIG. 4A illustrates an assembled state of heating jacket 62 and FIG. 4B illustrates heating jacket 62 in a disassembled state. A first insulation layer 70 surrounds gas pipe 56 and provides electrical insulation between gas pipe 56 and first and second hot wires 50 and 52. First and second hot wires 50 and 52 heat gas pipe 56 and are wound around first insulation layer 70. Second insulation layer 72 surrounds first and second hot wires 50 and 52 to provide electrical insulation therefore. Fixation layer 74 surrounds and securely retains the second insulation layer 72 in place.

In operation, power is supplied by the AC unit and a voltage is dropped and rectified in rectifying unit 40 thereby providing a DC voltage to MPU 42. MPU 42 turns on power supply controller 46 and supplies AC power to relay 48 which selects first hot wire 50 in response to the relay switching signal from MPU 42. Power supply controller 46 supplies AC power to first hot wire 50 which heats gas pipe 56. When first hot wire 50 reaches a predetermined temperature within a predetermined time, MPU 42 lights up first LED 60 with a particular color, such as green. When hot wire 50 is not at the predetermined temperature, MPU 42 lights up the first LED 60 with a different color, for example red. When gas pipe 56 is heated, gas flowing in gas pipe 56 is likewise heated preventing gas from crystallizing and adhering to pipe 56. When gas pipe 56 is heated by first hot wire 50, temperature sensor 54 senses the temperature of the first and second hot wires 50 and 52 and supplies the temperature reading to A/D converter 44. A/D converter 44 converts the sensed temperature into a digital signal and applies it to MPU 42 which compares this digital temperature with a predetermined temperature. If the measured temperature is lower than the predetermined temperature, power supply controller 46 is turned on to supply AC power to first hot wire 50 so as to heat gas pipe 56. If the measured temperature is higher than the predetermined temperature, power supply controller 46 turns off AC power to first hot wire 50. In the event that the temperature sensed by temperature sensor 54 does not reach the predetermined temperature within a predetermined time, MPU 42 determines that first hot wire 50 is damaged and provides a relay switching signal to relay 48. Relay 48 receives this relay switching signal from MPU 42 and supplies AC power to second hot wire 52 via power supply controller 46. In this manner, the temperature of gas pipe 56 is controlled by second hot wire 52. MPU 42 lights up second LED 60 to indicate a temperature control state of gas pipe 56 through second hot wire 52. That is, when second hot wire 52 reaches a predetermined temperature within a predetermined time, second LED 62 lights up with a color, for example green, to indicate a normal state. If the predetermined temperature is not reached, second LED 62 lights up with a different color, such as red, to indicate a failed state.

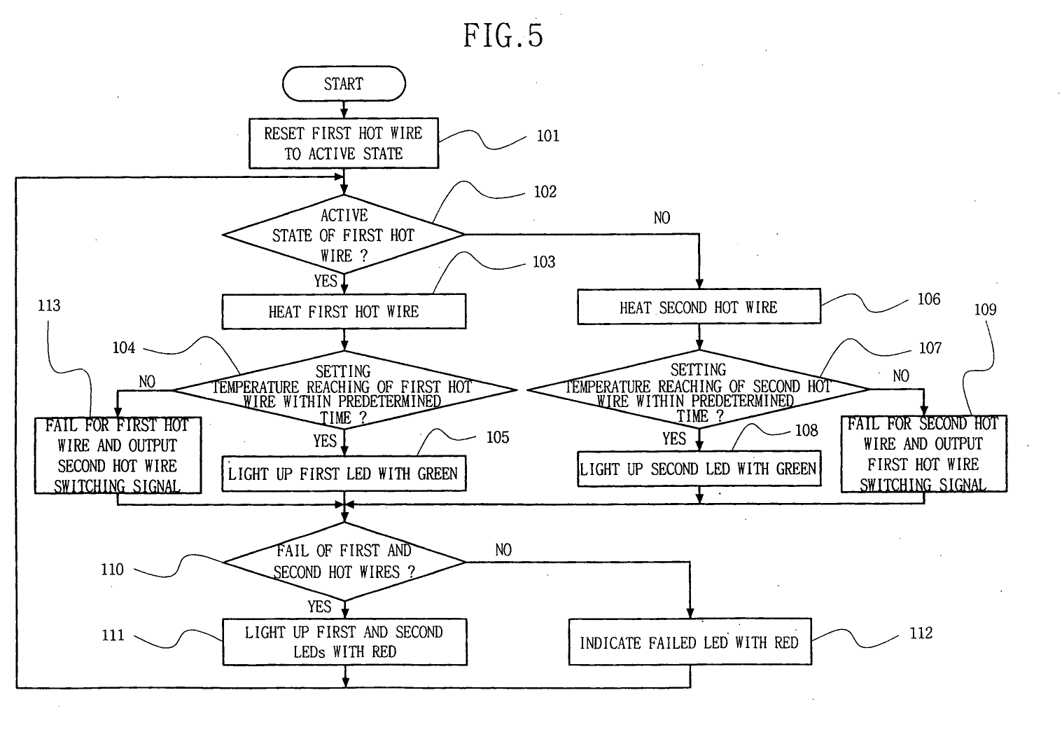

FIG. 5 is a flowchart illustrating a method of switching from first hot wire 50 to second hot wire 52 by MPU 42 when the first hot wire is damaged or otherwise not operating properly. In step 101, MPU 42 resets first hot wire 50 to an active state and is verified at step 102. In step 103, MPU 42 outputs a first switching signal to supply AC power through power supply controller 46 to first hot wire 50 so as to heat the first hot wire 50. In step 104, MPU 42 checks whether or not temperature of the first hot wire 50 sensed by temperature sensor 54 and received through A/D converter 44 reaches a predetermined temperature within a predetermined time. If the predetermined temperature is reached, MPU 42 turns on first LED 58 to indicate a drive state of first hot wire 50 at step 105. If first hot wire 50 does not reach the predetermined temperature within the predetermined time, hot wire 50 is in a fail state and second hot wire 52 is set to an active state at step 113. Also at step 113, a switching signal selects second hot wire 52 and relay 48 supplies AC power through power supply controller 46 to second hot wire 52 to heat the second hot wire.

At step 102, a determination is made whether or not first hot wire 50 is in an active state. If first hot wire is not in an active state, MPU 42 outputs second switching signal to apply AC power through power supply controller 46 to second hot wire 52 so as to heat the second hot wire 52 at step 106. In step 107, MPU 42 checks whether or not the temperature of second hot wire 52 sensed by temperature sensor 54 and received through A/D converter 44 reaches a predetermined temperature within a predetermined time. If second hot wire 52 reaches a predetermined temperature within a predetermined time, MPU 42 turns on the second LED 60 in the step 108 to indicate a drive state of second hot wire 52. If second hot wire 52 does not reach the predetermined temperature within a predetermined time, hot wire 52 is in a fail state and first hot wire 52 is set to an active state at step 109 and outputs a switching signal to select first hot wire 50. A determination is made at step 110 whether the first and second hot wires 50 and 52 are in a fail state. If the hot wires are in a fail state, MPU 42 turns on first and second LEDs 58 and 60 with a particular color, for example red, at step 111. If one of the first and second hot wires 50 and 52 are not in a fail state, at step 112 MPU 42 lights up the LED not indicating the fail state with a particular color, for example, green and the LED indicating the fail state with a particular color, for example green, and the process returns to step 102. For example, if first hot wire 50 is in a fail state, first LED 58 lights up with the color red and second LED 60 lights up with green.

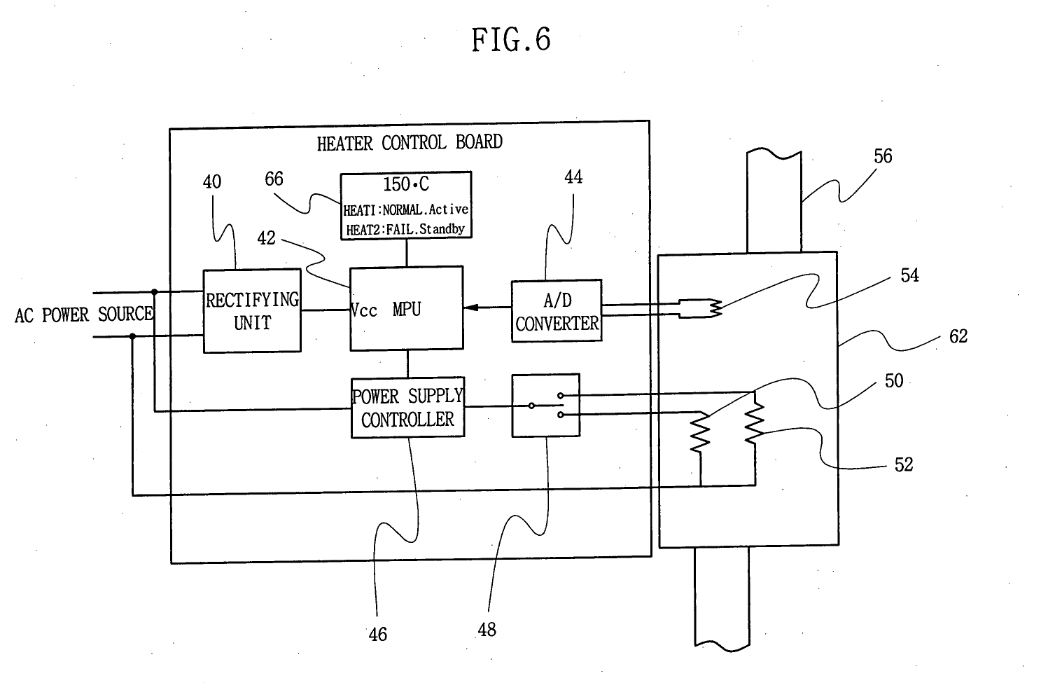

FIG. 6 illustrates rectifying unit 40 which receives AC power, drops a voltage, rectifies it and outputs DC power. MPU 42 receives DC power source supplied from rectifying unit 40 and outputs a control signal to heat first and second hot wires 50 and 52 to a predetermined temperature in response to a sensed temperature value. If the sensed temperature does not reach a predetermined temperature within a predetermined time period, MPU 42 outputs a relay switching signal and outputs a control signal to indicate a normal or fail state of first and second hot wires 50 and 52. Power supply controller 46 provides or cuts-off AC power in response to the control signal from MPU 42. First and second hot wires 50 and 52 surround gas pipe 56 and are heated by AC power supplied from power supply controller 46. Relay 48 selectively supplies power from power supply controller 46 to first or second hot wire 50 or 52 in response to relay switching signal from MPU 42. Temperature sensor 54 senses the temperature of first and second hot wires 50 and 52. A/D converter 44 converts the sensed temperature by temperature sensor 54 into a digital signal and provides it to MPU 42. A display 66 indicates the temperature and a normal or fail state of first and second hot wires 50 and 52. Display 66 also provides an active or standby state of first and second hot wires 50 and 52 in response to a control signal from MPU 42. Rectifying unit 40, MPU 42, A/D converter 44, power supply controller 46 and relay 48 may be included in heater control board 64. Power supply controller 46 may be constructed of a solid state relay (SSR).

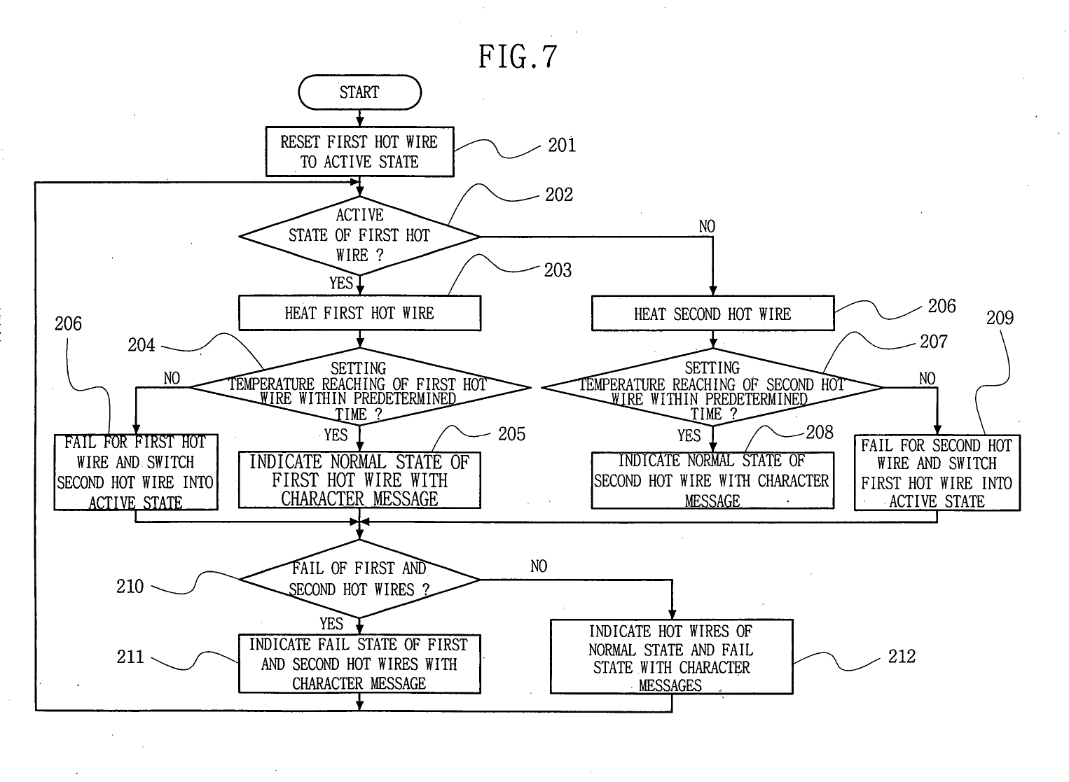

FIG. 7 is a flowchart illustrating a control flow of MPU 42 to switch from one hot wire to another when a hot wire is damaged or otherwise not functioning properly. In step 201, MPU 42 resets first hot wire 50 to an active state and MPU 42 checks whether first hot wire 50 is in an active state at step 202. If first hot wire 50 is in an active state, MPU 42 outputs a first switching signal to enable relay 48 to provide AC power to first hot wire 50 via power supply controller 46 at step 203. In step 204, MPU 42 checks whether or not the temperature of first hot wire 50, sensed by temperature sensor 54 and received through A/D converter 44, reaches a predetermined temperature within a predetermined time. If first hot wire 50 reaches the predetermined temperature, MPU 42 indicates that first hot wire 50 is in a normal state via an exemplary message, for example “Normal” or “Active”. If the temperature of first hot wire 50 does not reach the predetermined temperature within the predetermined time, step 206 decides that first hot wire 50 is in a fail state and sets second hot wire 52 to an active state.

If first hot wire 50 is not in an active state as determined at step 202, MPU 42 outputs second switching signal to relay 48 to supply AC power to second hot wire 52 via power supply controller 46 to heat second hot wire 52 in step 206. In step 207, MPU 42 checks whether or not the temperature of second hot wire 52, sensed by temperature sensor 54 and received through A/D converter 44, reaches a predetermined temperature within a predetermined time. Display 66 indicates that second hot wire 52 is in a normal state via display of a character or text message, for example, “Normal, Active” at step 208. When second hot wire 52 does not reach the predetermined temperature within a predetermined time, second hot wire 52 is in a failed state and first hot wire 50 is set to an active state at step 209. In step 210, MPU 42 checks whether both first and second hot wires 50 and 52 are in a fail state. If both first and second hot wires 50 and 52 are in a fail state, display 66 indicates this condition and returns to step 202. If one of the first or second hot wires 50 or 52 is not in a fail state, step 212 is performed in which MPU 42 indicates a normal state for the hot wire not in a fail state and indicates a fail state for the hot wire not in the normal state and returns to step 202. For example, if first hot wire 50 is in a fail state, display 66 indicates such condition by displaying, for example “Normal, Active”. If second hot wire 52 is in a fail state, display 66 indicates such condition by displaying, for example “Fail, Standby”.

In this manner, a temperature control apparatus utilizes first and second hot wires to heat a gas pipe during semiconductor manufacturing. When one hot wire having an active state does not reach a predetermined temperature within a predetermined time, the apparatus switches to the other hot wire which is in a standby state to heat the gas pipe. By providing a plurality of hot wires to heat the gas pipe, crystallization of gas within the pipe is avoided thereby preventing pipe blockage which may produce semiconductor process errors.

Although the present invention has been described in connection with the embodiment of the present invention illustrated in the accompanying drawings, it is not limited thereto. It will be apparent to those skilled in the art that various substitutions, modifications and changes may be thereto without departing from the scope and spirit of the invention.

What is claimed is:

1. A temperature control apparatus of a heating jacket utilized in semiconductor manufacturing, said apparatus comprising:
first and second hot wires for heating a gas pipe;
a temperature sensor configured to sense a temperature of said first and second hot wires; and
a controller configured to receive said temperature sense signal and outputting a control signal to heat said first or second hot wires to a predetermined temperature in response to said temperature sense signal, said controller outputting a relay switching signal to heat one of said first or second hot wires when said sensed temperature does not reach an associated predetermined temperature within a predetermined time period.

2. The apparatus of claim 1 further comprising:
a power supply controller connected to said controller for supplying or cutting off AC power to said first or second hot wires in response to said control signal; and
a relay configured to receive said relay switching signal from said controller, said relay selectively supplying said AC power to said first or second hot wires in response to said switching signal.

3. The apparatus of claim 1, further comprising a display for respectively indicating drive states of said first and second hot wires in response to said control signal.

4. The apparatus of claim 3, wherein said display comprises a first and second light emitting diodes (LEDs), said first LED indicates a normal or fail state of said first hot wire and said second LED indicates a normal or fail state of said second hot wire.

5. A temperature control apparatus for a heating jacket, comprising:
first and second hot wires for heating a gas pipe;
a temperature sensor for sensing a heating temperature of said first and second hot wires;
an analog-to-digital converter for converting said temperature sense signal into a digital temperature sense signal;
a controller configured to receive said digital temperature sense signal and outputting a control signal to heat said first or second hot wires to a predetermined temperature in response to said digital signal, said controller outputting a relay switching signal to heat one of said first or second hot wires when said sensed temperature does not reach an associated predetermined temperature within a predetermined time period, said control signal indicating a normal or fail state of said first and second hot wires;
a power supply controller connected to said controller for supplying or cutting off AC power to said first or second hot wires in response to said control signal; and
a relay configured to receive said relay switching signal from said controller, said relay selectively supplying said AC power to said first or second hot wires in response to said switching signal.

6. The apparatus of claim 5, further comprising a display indicating a temperature and a normal or fail state of said first and second hot wires, said display configured to display an active or standby state of said first and second hot wires in response to said control signal.

7. The apparatus of claim 5, further comprising a display for individually indicating drive states of said first and second hot wires in response to said control signal.

8. The apparatus of claim 7, wherein said display comprises first and second LEDs.

9. The device of claim 8, wherein said first LED indicates a normal or fail state associated with said first hot wire, said second LED indicates a normal or fail state of said second hot wire.
